(19) United States
(12) Patent Application Publication
(10) Pub. No.: US 2004/0169987 A1
(43) Pub. Date: Sep. 2, 2004

(54) Electronic relay controller

(76) Inventor: Robert Green, Santa Ana, CA (US)

Correspondence Address: Norman E. Carte, Myers Dawes Andras & Sherman LLP, Suite 1150, 19900 MacArthur Blvd., Irvine, CA, 92612, US

(21) Appl. No.: 10/377,321

(22) Filed: Feb. 28, 2003

(51) Int. Cl. H01H 47/02

(52) U.S. Cl. 361/160

(57) ABSTRACT

A method for controlling a relay, switch or other electromechanical device comprises delaying a change of state of the relay, switch or other electromechanical device until at least one electrical parameter associated with contacts thereof is within a desired range. The life of the relay, switch or other electromechanical device is increased and/or the current rating thereof is increased.

### BACKGROUND OF THE INVENTION

1. Field of the Invention

The present invention relates generally to relays. It relates more particularly to an electronic controller for delaying a change of state of a relay, switch or the like until an electrical parameter of the contacts thereof is within a desired range.

2. Description of the Prior Art

Mechanical relays for switching electricity are well known. Such mechanical relays have been in common use for over 100 years and in that time the art has produced relays of generally satisfactory design and reasonably low cost.

Although such contemporary mechanical relays have proven generally suitable for their intended purposes, they possess inherent deficiencies which detract from their overall effectiveness and desirability. For example, contemporary relays suffer from the problem of not controlling the point at which the relay contacts open or close with respect to the power line sinusoidal current cycle (and therefore not controlling how much current will be passing through the contacts when they open or close). Relays have consequently been de-rated, especially on incandescent and motor loads (which tend to draw increased current on startup), in order to accommodate this problem. That is, contemporary relays are constructed so as to accommodate the unfortunate fact that they will often be required to open and close with full current or greater than full current flowing through the contacts thereof.

Full current, as used herein, is defined as the greatest amount of current that a load draws when the load is being operated on a steady state basis (as occurs after startup of an incandescent or motor load, for example). Thus, greater than full current typically occurs during the startup of an incandescent or motor load.

Contemporary relays must be therefore rated at a value in excess of the full current value and must be able to accommodate opening and closing of the contacts thereof at the rated value. In order to achieve such a rating, the contacts of a relay must be heavier and have greater surface area than is necessary to accommodate the amount of current that flows therethrough when the contacts are closed. Such construction, of course, undesirably increases the cost of contemporary relays.

Thus, for example, in order to control a load of 1 KW or 8.69 amps on a 115 VAC line, the relay contacts must be designed to handle switching at the peak of the line current cycle. The relay contacts must be able to switch a load of 8.69×1.4=12.2 amps. The problem is worse for incandescent loads. An incandescent bulb has a lower resistance when cold than when hot. If the difference is three times, then a hot 1 kw-lamp load is 8.69 amps, but the cold current is 26 amps on start up. If lamps are turned on at peak voltage (thus drawing peak current), then the peak current is 26 amps×1.4 or 36 amps. This requires a relay to be designed to handle 4.2 times more current at turn on than when running.

Start up motor load currents may be higher than three times the running current and consequently result in the same problem discussed above with respect to incandescent loads.

Contemporary mechanical relays also have a serious problem with undesirable arcing across the contacts thereof. An arc is produced when relay contacts open and the current in the circuit is not zero. Such arcing undesirably eats away at the contact each time the relay opens, thus decreasing the useful life of the relay. Motor loads, with their inductive component, are especially problematic with respect to producing arcs.

In an attempt to overcome the problems associated with contemporary mechanical relays, the prior art has turned to the use of solid state devices. The use of silicon controlled rectifiers or triacs instead of mechanical relays produces the desired results of turning on and off at zero voltage and zero current, but such solid state devices have undesirably high power dissipation caused the voltage drop inherent in such solid state devices. This high power dissipation necessitates the use of heat sinking of the solid state devices and thus undesirably adds size and cost to such devices.

Another attempt to overcome the problems associated with contemporary mechanical relays involves the use of a hybrid of solid state devices and mechanical relays. In this configuration, the solid state device turns on before the closure of the mechanical relay and remains on after the mechanical relay opens until the current goes to zero.

However, the above methods are prone to failure of the solid state devices caused by voltage or current spikes occurring above the devices' voltage and/or current ratings. This failure mode may occur even if the over voltage or current is of a short duration. Solid state devices are also unable to provide complete disconnect from the power lines. The lack of complete disconnect inherently presents an undesirable shock hazard, even when the relays are turned off.

The hybrid relay is used to reduce the need for heat sinking, but requires additional parts to prevent drastic failure if the mechanical relay fails. Further, the voltage drop across the solid state devices of the hybrid relay still undesirably requires the mechanical relay contacts be rated for full peak switching current.

The hybrid relay increases the life of the mechanical relay by reducing arcing when the contacts of the mechanical relay open, however there is little or no increase in life when the contacts close.

The aforementioned problems discussed in relation to relays also occur in mechanical switches, as well as other electro-mechanic devices which have contacts.

The changing of the state of relays, switches and other such devices at points in the power line sinusoidal current cycle other than the zero current crossing tends to undesirably affect the balance of the utility power lines. As those skilled in the art will appreciate, such abrupt changes in the load sensed by the utility power lines can result in excessive currents within the utility power lines that can result in damage to power line utility equipment, as discussed further below.

The changing of the state of relays, switches and other such devices at points in the power line sinusoidal current cycle other than the zero current crossing tends to generate undesirable noise on the power lines. This noise can interfere with the operation of electrical devices such as radios, televisions, computers and the like.

Thus, although the prior art has recognized, to a limited extent, the problems associated with the opening and closing of the contacts of a relay with current flowing therethrough, the proposed solutions have, to date, been ineffective in providing a satisfactory remedy. Therefore, it is desirable to provide a device and method for causing the contacts of a relay, switch or the like to open and close when an electrical parameter, such as current flowing through the contacts, is within a predetermined range, such as approximately zero.

### BRIEF SUMMARY OF THE INVENTION

The present invention specifically addresses and alleviates the above mentioned deficiencies associated with the prior art. More particularly, the present invention comprises a device and method for delaying a change of state of a relay, switch or the like until at least one electrical parameter associated with contacts thereof is within a desired range. Thus, for example, a relay can be made to operate in a manner which reduces the cost thereof and/or extends the life thereof.

These, as well as other advantages of the present invention, will be more apparent from the following description and drawings. It is understood that changes in the specific structure shown and described may be made within the scope of the claims, without departing from the spirit of the invention.

While the apparatus and method has or will be described for the sake of grammatical fluidity with functional explanations, it is to be expressly understood that the claims, unless expressly formulated under 35 USC 112, are not to be construed as necessarily limited in any way by the construction of “means” or “steps” limitations, but are to be accorded the full scope of the meaning and equivalents of the definition provided by the claims under the judicial doctrine of equivalents, and in the case where the claims are expressly formulated under 35 USC 112 are to be accorded full statutory equivalents under 35 USC 112. The invention can be better visualized by turning now to the following drawings wherein like elements are referenced by like numerals.

### BRIEF DESCRIPTION OF THE DRAWINGS

The invention and its various embodiments can now be better understood by turning to the following detailed description of the preferred embodiments which are presented as illustrated examples of the invention defined in the claims. It is expressly understood that the invention as defined by the claims may be broader than the illustrated embodiments described below.

FIG. 1 is an electrical schematic of a first embodiment of an electronic relay controller of the present invention;

FIG. 2 is a timing diagram showing the timing relationships of signals and conditions associated with the electronic relay controller of FIG. 1;

FIG. 3 is a an electrical schematic of a second embodiment of an electronic relay controller of the present invention;

FIG. 4 is a an electrical schematic of a third embodiment of an electronic relay controller of the present invention; and

FIG. 5 is a flow chart showing the operation of a microprocessor according to the present invention.

### DETAILED DESCRIPTION OF THE INVENTION

Many alterations and modifications may be made by those having ordinary skill in the art without departing from the spirit and scope of the invention. Therefore, it must be understood that the illustrated embodiment has been set forth only for the purposes of example and that it should not be taken as limiting the invention as defined by the following claims. For example, notwithstanding the fact that the elements of a claim are set forth below in a certain combination, it must be expressly understood that the invention includes other combinations of fewer, more or different elements, which are disclosed in above even when not initially claimed in such combinations.

The words used in this specification to describe the invention and its various embodiments are to be understood not only in the sense of their commonly defined meanings, but to include by special definition in this specification structure, material or acts beyond the scope of the commonly defined meanings. Thus if an element can be understood in the context of this specification as including more than one meaning, then its use in a claim must be understood as being generic to all possible meanings supported by the specification and by the word itself.

The definitions of the words or elements of the following claims are, therefore, defined in this specification to include not only the combination of elements which are literally set forth, but all equivalent structure, material or acts for performing substantially the same function in substantially the same way to obtain substantially the same result. In this sense it is therefore contemplated that an equivalent substitution of two or more elements may be made for any one of the elements in the claims below or that a single element may be substituted for two or more elements in a claim. Although elements may be described above as acting in certain combinations and even initially claimed as such, it is to be expressly understood that one or more elements from a claimed combination can in some cases be excised from the combination and that the claimed combination may be directed to a subcombination or variation of a subcombination.

Insubstantial changes from the claimed subject matter as viewed by a person with ordinary skill in the art, now known or later devised, are expressly contemplated as being equivalently within the scope of the claims. Therefore, obvious substitutions now or later known to one with ordinary skill in the art are defined to be within the scope of the defined elements.

The claims are thus to be understood to include what is specifically illustrated and described above, what is conceptionally equivalent, what can be obviously substituted and also what essentially incorporates the essential idea of the invention.

Thus, the detailed description set forth below in connection with the appended drawings is intended as a description of the presently preferred embodiments of the invention and is not intended to represent the only forms in which the present invention may be constructed or utilized. The description sets forth the functions and the sequence of steps for constructing and operating the invention in connection with the illustrated embodiments. It is to be understood, however, that the same or equivalent functions may be accomplished by different embodiments that are also intended to be encompassed within the spirit of the invention.

The present invention comprises an electronic circuit or device and a method or program for controlling the closing and opening of the contacts of a mechanical relay, a switch, or any similar electromechanical device. The method of the present invention is used to synchronize the operation of a relay with respect to a periodic waveform, such as the current of an AC power line. Such control of the opening and closing of the relay contacts allows high currents and power loads to be switched on or off at a time when little or no voltage or current is across the contacts of the relay.

Although generally described herein as being applied to a relay, those skilled in the art will appreciate that the present invention is also applicable to switches and other electromechanical devices. Thus, such description of a relay is by way of example only and not by way of limitation.

The method of the present invention prevents pitting and arcing of the contacts of a relay and is able to produce increases in the load switching capability and operating life of the relay. The power switching load capability using this method is only limited by the current carrying capability of the relay in the on mode and not by contact switching parameters. A four to twenty times increase in current capability can be realized on some loads. With this method the life of the relay is increased up to ten times and is only limited by the specified number of rated mechanical operations and not limited by the rated life of contact operations under load conditions.

Another result of such controlled switching is the decrease or elimination of electrical noise. Electrical noise is mitigated since arcing between the contacts of the relay is minimized.

The method of the present invention also provides for integral cycle switching of the AC line. Integral cycle switching requires the relay to be on for full cycles of the AC line. Full cycle on time keeps the power lines balanced saving energy and preventing transformers in the power system from saturating and creating destructive power line voltage transients.

The present invention preferably utilizes a microcontroller or microprocessor based circuit. Alternatively, the present invention may utilize discrete components for the logic aspects thereof. If a microprocessor is used, additional functions can be added to the program with no increase in components or cost, or the relay switching algorithm may be added to an existing microprocessor control program to increase the life and performance of mechanical relays or eliminate the need for solid state relays.

Thus, the present invention comprises a method for controlling the opening and closing of the contacts of a relay at any desired point in time. The function of the operation may be synchronized with an external input to produce a relay circuit that opens and closes when the power line is at zero voltage or zero current, as well as when the voltage or current is at any other desired value.

Using the zero crossing of the voltage or current of the AC line as a reference, the present invention adds a delay time to the inherent delay time of the relay to open or close the contacts at the next zero crossing of the AC line or at any other desired point.

Some embodiments of the present invention comprise a microprocessor that is programmed to provide the timing and logic required. The timing circuits produce a delayed signal to the coil of a relay in order to synchronize the closing or opening of the contacts of a relay. In this manner the contacts of the relay can be set to open or close at the next zero voltage or zero current crossing of the AC line. This method is not limited to synchronizing with the zero crossing of an AC line, but also applies to switching at any point in the cycle of any periodic signal. For example it is sometimes desired to switch at other times or at the peak of the AC line.

Thus, switching may be effected, according to the present invention, at any desired point on any generally periodic waveform and is thus not limited to the sinusoidal power line current cycle.

The inherent relay on delay time is the time it takes for the relay contacts to close after the coil voltage is applied and the inherent off delay is the time it takes from the removal of voltage on the coil to the opening of the contacts. The delay time is dependent on the mechanical design of the relay and the voltage across the coil of the relay. The on delay is dependent on the voltage applied across the relay coil, but the off delay is dependent on the reverse voltage allowed across the coil.

Modern production of relays has resulted in relays of any one type having very close on and off inherent delays that remain stable with time. This invention uses the zero crossing of the AC line to initialize a timer. The timer adds a delay to the inherent delay of the opening or closing of the relay contacts in order to open or close the contacts of the relay at the next zero crossing of the voltage or current of the AC line.

In most production applications the on delay and the off delay need only to be set for the type of relay used. The on and off delay is a number used to compare against the count of the microprocessor timer and may be written into the microprocessor program. If the expected load on the line has a power factor, it maybe desirable to set the off delay longer or shorter to match the lead or lag of the current in order to change state at zero current and not at zero voltage.

Thus, the present invention comprises a method for controlling a relay, the method comprising delaying a change of state of the relay until at least one electrical parameter associated with contacts of the relay is within a desired range. The present invention preferably further comprises receiving a control signal, preferably an electronic control signal, which indicates that the relay is to change the state thereof, the control signal initiating the delaying of the change of state.

However, those skilled in the art will appreciate than in some instances an external control signal will not be necessary. For example, the microprocessor itself may determine when the relay is to change state. This may occur if the microprocessor is a controller which runs a program and the program, with or without external input, determines when the relay is to change state.

Further, the control signal need not necessarily be electronic. Those skilled in the art will appreciate that various other types of control signals are likewise suitable. For example, the control signal may alternatively be mechanical, optical, pneumatic, electromagnetic or of any other type.

The desired parameter or parameters are monitored to facilitate determination of when the parameters are within the desired range. It is important to appreciate than any desired types of parameters and any desired number of parameters may be monitored. For example, it may be desirable to effect the change of state of a relay when current through the contacts of the relay is zero and when the voltage across the contacts of the relay or across any desired component are a predetermined value or within a predetermined range. Thus, the present invention can monitor a plurality of desired parameters and cause the contacts of a relay to change state when any desired combination of parameters is present.

The present invention preferably comprises monitoring the parameter(s) and starting a counter when one of the parameters is approximately at a predetermined value to facilitate determination of when the parameter is within the desired range. The change of state of the relay is effected at a predetermined count of the counter. For example, the counter may be configured to provide a count of at least 100 between consecutive points of substantially identical phase of the monitored parameter(s) (such as the zero crossing of current) and closing of the contacts of a relay may be commanded by the microprocessor at a count of 95, knowing that by the time the relay reacts, the zero crossing of current through the contacts will once again occur. Of course, the present invention can be configured such that any desired point on any periodic waveform initiates the count and such that the change of state of the relay occurs at any desired point on the periodic waveform.

The monitored parameter can be an electrical parameter such as voltage, current or power. It can also be a non-electrical parameter such as vibration, magnetic field strength, the position of a rotor, or any other desired parameter.

Preferably, the desired range is within 160 microseconds of a zero crossing of at least one parameter. Changing the state of a relay within this desired range substantially reduces undesirable arcing of the contacts of a relay and substantially increases the relay's life. Although the change of state is generally desired to occur at approximately the zero crossing of current, the change of state can alternatively be delayed until some time other than approximately the zero crossing of any desired parameter.

Delaying the change of state of the relay is preferably controlled by a microprocessor. However, as those skilled in the art will appreciate, the delay may alternatively be provided, in whole or in part, by circuitry external to the microprocessor. For example, the delay may be provided by an oscillator, clock or counter external to the microprocessor or completely replacing the microprocessor.

The processor may either be a general purpose microprocessor or a custom built application specific microprocessor.

The change of state may be the opening of contacts, the closing of contacts, or may include both the opening and closing of different sets of contacts. Thus, in a multiple contact relay, some contacts may open at the same time that other contacts are closing. Further, the controller of the present invention may control a plurality of separate relays.

According to one aspect, the present invention comprises monitoring a desired electrical parameter associated with contacts of the relay, starting a counter when the parameter is approximately at a predetermined value, receiving a control signal which indicates that the contacts are to change state; and effecting a change of state of the relay at a predetermined count of the counter in response to receiving the control signal.

According to another aspect, the present invention comprises using a microprocessor to determine when the relay changes state in response to a control signal.

According to yet another aspect, the present invention comprises synchronizing opening and closing of contacts of the relay with respect to a predetermined point on a periodic waveform.

According to yet another aspect, the present invention comprises a method for controlling a circuit breaker, the method comprising delaying a change of state of the circuit breaker until at least one electrical parameter of contacts of the circuit breaker is within a desired range.

According to yet another aspect, the present invention comprises a method for controlling a switch, the method comprising delaying a change of state of the switch until at least one electrical parameter of contacts of the switch is within a desired range.

According to yet another aspect, the present invention comprises a method for controlling a motor, the method comprising delaying a change of state of a switch which provides electricity to the motor until at least one electrical parameter of contacts of the switch is within a desired range.

According to yet another aspect, the present invention comprises a method for enhancing balance of power lines and for mitigating noise thereon, the method comprising switching loads onto and off of the power lines when current through a switch is approximately zero.

According to yet another aspect, the present invention comprises a device for controlling a relay, the device comprising a delay circuit configured to delay a change of state of the relay until at least one electrical parameter associated with contacts of the relay is within a desired range. A control signal input port receives a control signal and provides a signal representative thereof to the delay circuit. The delay circuit is configured to initiate the delaying of the change of state when the control signal is received.

According to yet another aspect, the present invention comprises a device for controlling a relay, the device comprising a microprocessor at least partially defining a counter, input control circuitry configured to communicate an input control signal to the microprocessor, the input control signal indicating that the relay is to change state, sample conditioning circuitry configured to condition a sample of a periodic waveform of electricity associated with contacts of the relay so as to make the sample compatible with the microprocessor, the sample conditioning circuitry then providing the sample to the microprocessor, and driver circuitry configured to receive an output control signal from the microprocessor and to cause the relay to change state in response to the output control signal. The sample causes the counter to reset when the sample is at a predetermined value and wherein the input control signal causes the microprocessor to provide the output control signal after waiting until the counter is at a predetermined value.

According to yet another aspect, the present invention comprises a relay comprising a coil and at least one set of contacts. The state of the contacts is responsive to the coil and to a relay controller which comprises a delay circuit configured to delay a change of state of the relay until at least one electrical parameter associated with the contacts is within a desired range. Preferably, the coil, the contacts and the relay controller are all disposed within a common housing.

According to yet another aspect, the present invention comprises a switch comprising an actuator and at least one set of contacts. The state of the contacts is responsive to the actuator and a switch controller comprises a delay circuit configured to delay a change of state of the contacts until at least one electrical parameter associated with the contacts is within a desired range.

According to yet another aspect, the present invention comprises a motor controller comprising a switch configured to provide electricity to a motor. The switch has contacts and circuitry which is configured to delay a change of state of the switch until at least one electrical parameter of the contacts is within a desired range.

According to yet another aspect, the present invention comprises a motor assembly comprising a motor, a switch which provides electricity to the motor and circuitry configured to delay a change of state of the switch until at least one electrical parameter of contacts of the switch is within a desired range.

According to yet another aspect, the present invention comprises a power line balancer comprising a switch configured to switch loads onto and off of power lines and circuitry configured to change a state of the switch when current through the switch is approximately zero.

According to a first embodiment, the present invention is configured to receive power to operate the microprocessor and the relay from a source other than a sample of the current controlled by the contacts of the relay. A voltage regulator assures that power provided to the microprocessor has the correct voltage and is conditioned sufficiently to assure reliable operation thereof.

According to a second embodiment, the present invention is configured to receive power to operate the microprocessor and the relay from the same source as the sample of the current controlled by the contacts of the relay. This embodiment eliminates the need for another source of power, as required in the embodiment described above. This embodiment also comprises at least one voltage regulator configured to receive electrical power from the sample and configured to provide electrical power to the microprocessor and the driver circuitry.

According to a third embodiment, the present invention is also is configured to receive power to operate the microprocessor and the relay from the same source as the sample of the current controlled by the contacts of the relay. However, according to this embodiment, the present invention comprises at least one zener diode configured to receive electrical power from the sample and configured to provide electrical power to the microprocessor and the driver circuitry. As those skilled in the art will appreciate, such zener diodes are substantially less costly than voltage regulators and are suitable for use with many microprocessors and microcontrollers.

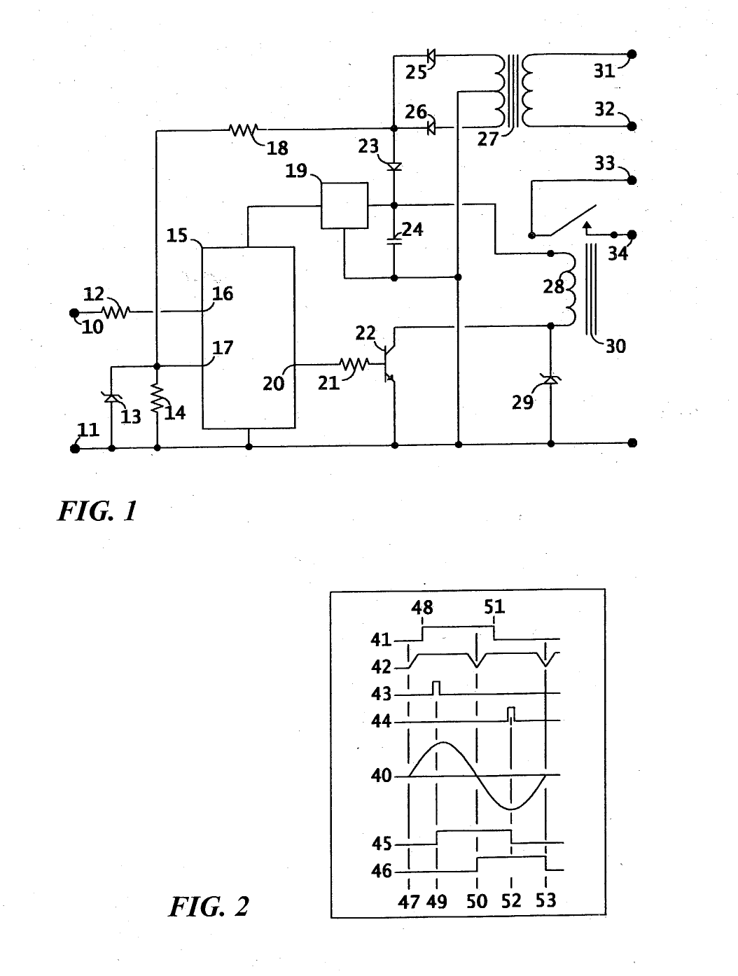

The present invention is illustrated in FIGS. 1 through 5, which depict presently preferred embodiments thereof.

Referring now to FIG. 1, according to the first embodiment, sampling of the AC line is performed separately from the AC power which is use to power the electronic relay controller. A microprocessor and a program provide timing and logic functions. As those skilled in the art will appreciate, the present invention may alternatively utilize a microcontroller. As yet a further alternative, the present invention may utilize discrete logic components.

The program which is executed by the microprocessor may be stored within the microprocessor, within solid state memory accessible by the microprocessor, or within any other desired device.

The microprocessor may be part of a general purpose computer, such as a personal computer, which cooperates with input circuitry (such as analog-to-digital converters) and output circuitry (such as digital-to-analog converters) to control the opening and closing of either a single relay or a plurality of relays. The exemplary electronic relay controller described herein utilizes a dedicated microprocessor or microcontroller to control the opening and closing of a single relay.

The AC line power is connected at terminals 31 and 32 to provide power to the microprocessor 15, the relay 30 and associated circuitry. When a control signal is applied to terminal 10, the relay output at terminals 33 and 34 closes at approximately the next zero crossing of the AC line. In the same manner when the control signal is removed from terminals 10 and 11, the output at 33 opens at the next zero crossing of the AC line.

The microprocessor 15 has a control input 16 which receives the control input signal from terminal 10, an AC line sample input 17 which receives a sample of the AC from terminal 11 and relay output 20 which provides a signal that effects actuation (closing of the contacts) of the relay 30. Removal of this signal from relay output 20 effect de-actuation (opening of the contacts) of the relay 30.

The control signal is preferably a voltage which is applied at terminal 10 applied through resistor 12 to input 16 of microprocessor 15. The sample of the AC line is preferably a voltage applied at input 17 of the microprocessor 15. Resistors 18, 14 and zener diode 13 provide voltage conditioning for microprocessor input 17. The output of the microprocessor 15 is provided through resistor 21 to transistor driver 22. Transistor driver 22 drives relay 30. Zener diode 29 assures a generally constant current discharge rate when the coil 28 of the relay 30 is de-energized and zener diode 29 also provides some voltage protection for the transistor driver 22.

Voltage regulator 19, voltage supply filter capacitor 24, power transformer 27, rectifier diodes 25, 26, and isolator diode 23 provide power to the microprocessor 15 and to the relay 30 according to well know principles.

Referring now to FIGS. 1 and 2, in operation a sample of the AC line voltage is applied to microprocessor input 17. Resistor 18 limits the current across zener diode 13. Zener diode 13 is used to limit the voltage on input 17 of the microprocessor 15. Resistor 14 is used as a load drain to assure the voltage at microprocessor input 17 goes to zero at each half cycle of the line and thus produces the waveform 42 in FIG. 2.

Resistor 12 limits any voltage transients on input 17 of microprocessor 15 from the control input at 10. Output 20 of microprocessor 15 is the relay switching output and applies voltage to transistor driver 22 through base current limiting resistor 21. The collector of transistor 22, when on, provides current to relay coil 28.

Zener diode 29 is used at turn off to limit the voltage across transistor 22 and allow a consistent current discharge rate to relay coil 28. Capacitor 24 is used to filter the supply voltage and is configured to conform to the requirements of the relay 30. The voltage across capacitor 24 also provides voltage for the microprocessor circuit through regulator 19 and is typically 5 volts.

A sample of the AC line voltage is provided to microprocessor input 17, after it is voltage limited by zener diode 13. The voltage waveform at 17 is shown in FIG. 2 as waveform 42. A zero input at 17 resets the timer of microprocessor 15 to zero. The microprocessor timer is preferably set to provide a count up to 255 for each full or half cycle of the AC line. However, as those skilled in the art will appreciate, the resolution of the switching time is dependent on the count of the microprocessor timer per line cycle time.

A count of 100, for example, results in a resolution of 1 percent. A one-percent resolution allows the relay contact to open or close within 160 microseconds of zero crossing of the line. As those skilled in the art will further appreciate, the count can be any number which the microprocessor is capable of accommodating and which provides the desired resolution.

In order to cause the relay to open and close at approximately the zero crossing of current through the contacts thereof, the timer count is compared with a preset number, referred to as the set on delay, to produce a gate function for turn on time and is compared to another number, referred to as the set off delay, to produce a different gate function for turn off time.

The turn on gate time is shown in FIG. 2 as waveform 43 and the turn off gate is FIG. 2 as waveform 44. An interrupt function or a range of gate on time may be used to aid microprocessor function. The on or off gate functions of waveforms 43 and 44 are used to enable output 20 waveform 45 of microprocessor 15.

When gate waveform 43 at time 49 is high and control input 10 waveform 41 is high, then output 20 waveform 45 is set high. When gate waveform 44 at time 52 is high and control input 10 waveform 41 is low, then output 20 waveform 45 is set low. Output 20 is applied to the relay driver transistor 22 through resistor 21. The relay coil 28 is activated or deactivated at a preset time after zero crossing of the line. The delay time after zero crossing plus the inherent relay delay time to close or open the contacts of the relay enables the relay contacts to close or open at the next zero crossing of the AC line. The waveform 46 of FIG. 2 represents the closing and opening of the relay contacts.

With particular to FIG. 2, at time 49 control input 10 waveform 41 is high and gate waveform 43 is also high. The result of this is that output 20 waveform 45 is set high, thus turning on transistor 22 and activating relay coil 28. The relay contacts close after the inherent relay on delay time, from time 49 to time 50 of FIG. 2.

Closing of the relay contacts is represented by waveform 46 at time 50. Turn off (opening of the contacts of relay 30) is the same type of function, except that at time 52 control input 10 waveform 41 is low and gate 37 is high. Then output 20 at time 52 is set low turning off transistor 21. After the inherent relay off delay time, from time 52 to time 53 of FIG. 2, the relay contacts open at time 53 as represented by waveform 46.

Optionally, the lead or lag off delay may be set automatically while in operation with a current sensor measuring the zero current time connected back to the microprocessor. The time from zero voltage crossing to the next zero current crossing is used as the periodic line cycle for the off set delay.

Similarly, the on set delay may also optionally be set automatically while in operation by using a transformer or a photo-isolated sensor across the load connected back to the microprocessor to compare the closing of the relay with the zero crossing of the AC line. The on set delay is then adjusted until the relay contacts close at zero voltage crossing of the AC line.

One optional method of obtaining the inherent on and off delay of the relay is to connect one contact of the relay to common and the other contact to an input of the microprocessor. With the microprocessor in a setup mode, the relay is activated at zero crossing of the line and the delay time from zero crossing to the relay contact closing is the inherent on delay of the relay. The inherent on delay of the relay is subtracted from the periodic cycle time of the line and the result is saved as the on set delay for the relay. In a like manner the relay coil is then turned off and the time is measured until the relay contacts open. This time is subtracted from the periodic cycle time of the line and is saved as the off set delay for the relay.

According to one aspect, the present invention may be used as a circuit breaker. When used as a circuit breaker the circuit would open at zero current on the line making it able to break high peak current overloads without arcing. As a circuit breaker the microprocessor is able to provide smart current sensing. A smart breaker is configured to distinguish the difference between expected loads, such as short-circuit loads, motor or incandescent and long term load currents above a preset level. A short circuit load would trip the breaker with a maximum time of 8 ms plus the inherent relay off delay time.

With the reverse voltage allowed across the relay coil 28 by zener diode 29, the current in the relay coil 28 is able to decay and allow the contacts of the relay to open in less then 1 ms. In most overload conditions the over current would be sensed at the peak of the AC cycle and the relay would open in less than 5 ms.

According to another aspect of the present invention, the microprocessor also monitors the power line for power factor and if a motor load is detected a delayed trip is enabled to a time desired for motor starting. The breaker would be set, however to trip whenever the wiring is in danger of overload.

As those skilled in the art will appreciate, this invention may also be implemented on three phase circuits in a manner similar to the above described implementation on a single phase.

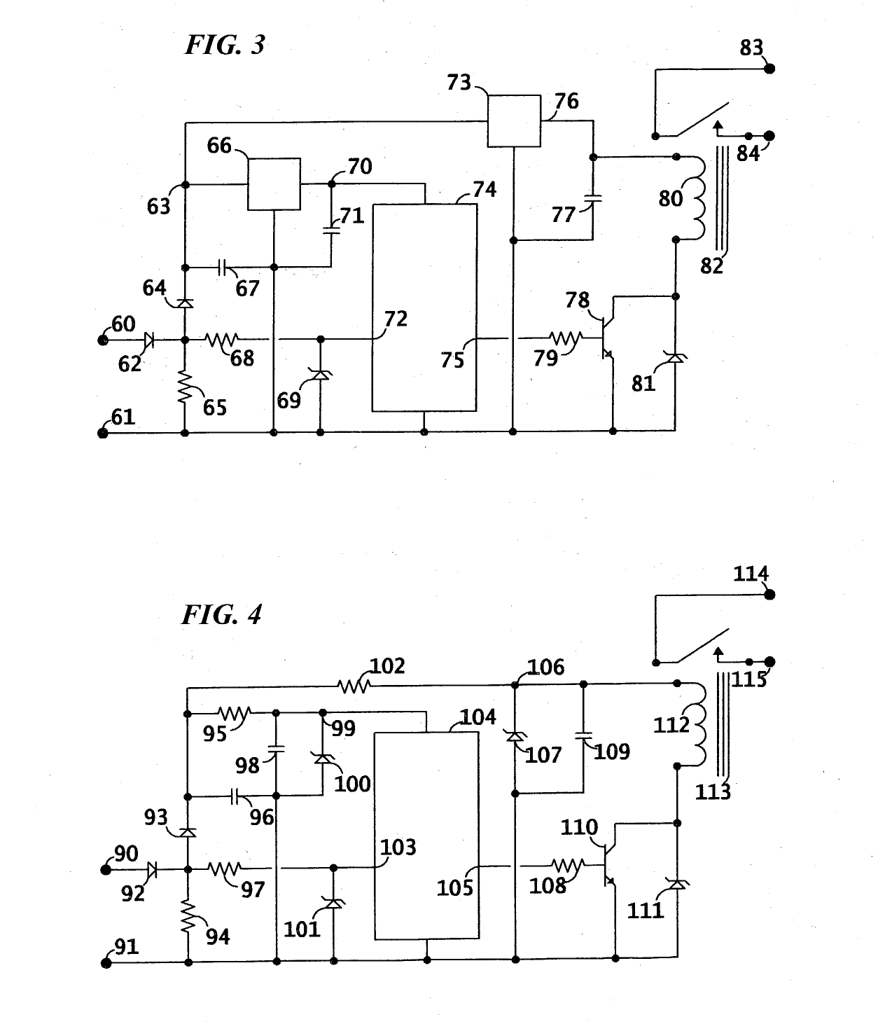

Referring now to FIG. 3, according to the second embodiment of the present invention, the relay zero crossing function is controlled by the input of a control voltage across terminals 60 and 61. The relay 82 is selected to match the control voltage applied across terminals 60 and 61. The control voltage may be AC or full wave unfiltered DC or half wave unfiltered DC. This method allows this invention to provide zero crossing switching in simple relay logic circuits. The zero crossing synchronizing input is provided by the control voltage applied at 60 to the microprocessor 74 input 72. Diode 62 prevents reverse voltage across zener diode 69 and input 72. Resistor 68 is used as a load drain.

According to the second embodiment of the present invention, power for the microprocessor 74 and for the relay 82 is provided by voltage regulators 66 and 73.

Referring now to FIG. 4, according to the third embodiment of the present invention, zener diodes 100 and 107 provide voltage regulation for the microprocessor 74. Smoothing capacitors 98 and 109 tend to smooth out irregularities in the voltage drop developed across zener diodes 100 and 107, respectively.

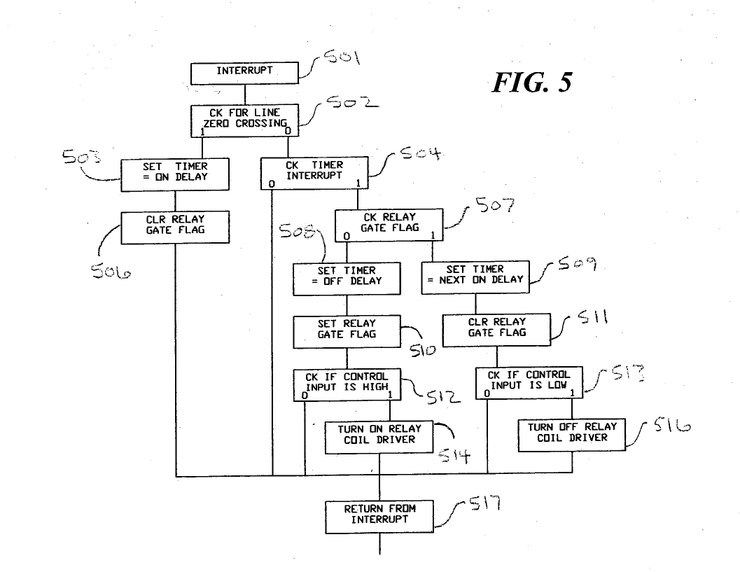

Referring now to FIG. 5, a microprocessor flow diagram for the zero crossing relay circuit of the present invention is provided. When an interrupt (block 501) occurs the input interrupt flag is checked for a zero crossing of the AC line (block 502).

If there is a zero crossing interrupt the timer is set to the on gate interrupt time (block 503) and the relay gate flag is cleared (block 506). If the interrupt is not a zero line crossing interrupt then the timer interrupt flag is checked (block 504). When there is a timer interrupt flag (block 507) the relay gate flag is checked.

If the relay gate flag is zero the timer is set to the off gate time (block 508) and the relay gate flag (block 510) is set and the control input is checked. If the control input is high (block 512) the relay driver is turned on (block 514). However if the relay gate flag is not zero, the timer is set to the next on time (block 509) and the relay gate flag is cleared (block 511) and if the control input is low (block 513) the relay driver is turned off (block 516). The on gate time (block 514) will be reset at the next zero crossing of the AC line to time. If the AC line is no longer present then time will be used to continue the timing until driver can be turned off or the AC line returns. When the process is completed, the system returns from interrupt (block 517). This method allows the control input to be the AC line reference and power source and when the control line is removed the relay will turn off at the next zero crossing of the line.

It is understood that the exemplary electronic relay controllers described herein and shown in the drawings represent only presently preferred embodiments of the invention. Indeed, various modifications and additions may be made to such embodiments without departing from the spirit and scope of the invention. For example, the microprocessor, microcontroller, or other control mechanism and any associated programming may be configured to cause the contacts of a relay, switch or similar device to change state at some point on a voltage, current or other waveform other than the zero-crossing point. Those skilled in the art will appreciate that the present invention may be configured to effect such a change of state at any desired point on any type of generally periodic waveform.

Thus, these and other modifications and additions may be obvious to those skilled in the art and may be implemented to adapt the present invention for use in a variety of different applications.

1. A method for controlling a relay, the method comprising delaying a change of state of the relay until at least one electrical parameter associated with contacts of the relay is within a desired range.

2. The method as recited in claim 1, further comprising receiving a control signal which indicates that the relay is to change the state thereof, the control signal initiating the delaying of the change of state.

3. The method as recited in claim 1, further comprising receiving an electronic control signal which indicates that the relay is to change the state thereof, the electronic control signal initiating the delaying of the change of state.

4. The method as recited in claim 1, further comprising monitoring the parameter(s) to facilitate determination of when the parameter(s) are within the desired range.

5. The method as recited in claim 1, further comprising monitoring the parameter(s) and starting a counter when one of the parameter(s) is approximately at a predetermined value to facilitate determination of when the parameter is within the desired range, the change of state of the relay being effected at a predetermined count of the counter.

6. The method as recited in claim 1, further comprising monitoring the parameter(s) and starting a counter when one of the parameter(s) is approximately at a predetermined value to facilitate determination of when the parameter is within the desired range, the change of state of the relay being effected at a predetermined count of the counter, the counter being configured to provide a count of at least 100 between consecutive points of substantially identical phase of the monitored parameter(s).

7. The method as recited in claim 1, wherein at last one parameter is voltage.

8. The method as recited in claim 1, wherein at least one parameter is current.

9. The method as recited in claim 1, wherein at least one parameter is power.

10. The method as recited in claim 1, wherein the desired range includes a zero crossing of at least one parameter.

11. The method as recited in claim 1, wherein the desired range is within 160 microseconds of a zero crossing of at least one parameter.

12. The method as recited in claim 1, wherein the change of state of the relay is delayed until approximately a zero crossing of at least one parameter.

13. The method as recited in claim 1, wherein the change of state of the relay is delayed until some time other than approximately a zero crossing of at least one parameter.

14. The method as recited in claim 1, wherein delaying the change of state of the relay is controlled by a microprocessor.

15. The method as recited in claim 1, wherein delaying the change of state of the relay is controlled by a general purpose microprocessor.

16. The method as recited in claim 1, wherein delaying the change of state of the relay is controlled by an application specific microprocessor.

17. The method as recited in claim 1, wherein the change of state of the relay is opening of contacts of the relay.

18. The method as recited in claim 1, wherein the change of state of the relay is closing of contacts of the relay.

19. The method as recited in claim 1, wherein the change of state of the relay includes both opening and closing of contacts of the relay.

20. A method for controlling a relay, the method comprising:
monitoring a desired electrical parameter associated with contacts of the relay;
starting a counter when the parameter is approximately at a predetermined value;
receiving a control signal which indicates that the contacts are to change state; and
effecting a change of state of the relay at a predetermined count of the counter in response to receiving the control signal.

21. A method for controlling a relay, the method comprising using a microprocessor to determine when the relay changes state in response to a control signal.

22. A method for controlling a relay, the method comprising synchronizing opening and closing of contacts of the relay with respect to a predetermined point on a periodic waveform.

23. A method for controlling a circuit breaker, the method comprising delaying a change of state of the circuit breaker until at least one electrical parameter of contacts of the circuit breaker is within a desired range.

24. A method for controlling a switch, the method comprising delaying a change of state of the switch until at least one electrical parameter of contacts of the switch is within a desired range.

25. A method for controlling a motor, the method comprising delaying a change of state of a switch which provides electricity to the motor until at least one electrical parameter of contacts of the switch is within a desired range.

26. A method for enhancing balance of power lines and for mitigating noise thereon, the method comprising switching loads onto and off of the power lines when current through a switch is approximately zero.

27. A device for controlling a relay, the device comprising a delay circuit configured to delay a change of state of the relay until at least one electrical parameter associated with contacts of the relay is within a desired range.

28. The device as recited in claim 27, further comprising a control signal input port for receiving a control signal and for providing a signal representative thereof to the delay circuit, the delay circuit being configured to initiate the delaying of the change of state when the control signal is received.

29. The device as recited in claim 27, further comprising a monitoring circuit configured to monitor the parameter(s) to facilitate determination of when the parameter(s) are in the desired range.

30. The device as recited in claim 27, wherein the delay circuit comprises a microprocessor.

31. The device as recited in claim 27, wherein the delay circuit comprises a general purpose microprocessor.

32. The device as recited in claim 27, wherein the delay circuit comprises an application specific microprocessor.

33. The device as recited in claim 27, wherein the delay circuit comprises discrete components.

34. The device as recited in claim 27, wherein the delay circuit comprises a counter for facilitating definition of the delay.

35. The device as recited in claim 27, wherein the monitoring circuit is configured to monitor voltage.

36. The device as recited in claim 27, wherein the monitoring circuit is configured to monitor current.

37. The device as recited in claim 27, wherein the monitoring circuit is configured to monitor power.

38. The device as recited in claim 27, wherein the delay circuit is configured to delay change state of the contacts until at least one of the parameter(s) is approximately zero.

39. The device as recited in claim 27, wherein the delay circuit is configured to delay change state of the contacts until at least one of the parameter(s) is within 160 microseconds of a zero crossing thereof.

40. The device as recited in claim 27, wherein the delay circuit is configured to delay change state of the contacts until at least one of the parameter(s) is not approximately zero.

41. A device for controlling a relay, the device comprising:
a microprocessor at least partially defining a counter;
input control circuitry configured to communicate an input control signal to the microprocessor, the input control signal indicating that the relay is to change state;
sample conditioning circuitry configured to condition a sample of a periodic waveform of electricity associated with contacts of the relay so as to make the sample compatible with the microprocessor, the sample conditioning circuitry then providing the sample to the microprocessor;
driver circuitry configured to receive an output control signal from the microprocessor and to cause the relay to change state in response to the output control signal; and
wherein the sample causes the counter to reset when the sample is at a predetermined value and wherein the input control signal causes the microprocessor to provide the output control signal after waiting until the counter is at a predetermined value.

42. The device as recited in claim 41, further comprising at least one voltage regulator configured to receive electrical power from the sample and configured to provide electrical power to the microprocessor and the driver circuitry.

43. The device as recited in claim 41, further comprising at least one zener diode configured to receive electrical power from the sample and configured to provide electrical power to the microprocessor and the driver circuitry.

44. A relay comprising:
a coil;
at least one set of contacts, the state of the contacts being responsive to the coil; and
a relay controller comprising a delay circuit configured to delay a change of state of the relay until at least one electrical parameter associated with the contacts is within a desired range.

45. The relay as recited in claim 44, wherein. the coil, the contacts and the relay controller are disposed within a common housing.

46. A switch comprising:
an actuator;
at least one set of contacts, the state of the contacts being responsive to the actuator; and
a switch controller comprising a delay circuit configured to delay a change of state of the contacts until at least one electrical parameter associated with the contacts is within a desired range.

47. A motor controller comprising:
a switch configured to provide electricity to a motor, the switch having contacts; and
circuitry configured to delay a change of state of the switch until at least one electrical parameter of the contacts is within a desired range.

48. A motor assembly comprising:
a motor:
a switch which provides electricity to the motor; and
circuitry configured to delay a change of state of the switch until at least one electrical parameter of contacts of the switch is within a desired range.

49. A power line balancer comprising:
a switch configured to switch loads onto and off of power lines; and
circuitry configured to change a state of the switch when current through the switch is approximately zero.
